(19) United States
(12) Patent Application Publication
(10) Pub. No.: US 2006/0003805 A1
(43) Pub. Date: Jan. 5, 2006

(54) System for accessing auxiliary content data

(75) Inventors: Nigel Richardson, Surrey (GB); Andrew Strawn, Hampshire (GB)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/158,230

(22) Filed: Jun. 22, 2005

(30) Foreign Application Priority Data
Jun. 30, 2004 (GB) 0414665.0

(51) Int. Cl. H04M 1/00

(52) U.S. Cl. 455/558; 455/556.1

(57) ABSTRACT

A communications system operates in a cellular communications network. The system includes user equipment having a first communications port. The user equipment is arranged to operate a application and a card for accessing options on the user equipment applications. The card includes a storage element storing information relating to the application in a form readable by the port. The user equipment is arranged to receive the card-stored information via the first communications port. The storage element information allows a user to access an option in the application in dependence on the stored information. A visual display element is arranged to display information dependent on the information representative of the option.

### FIELD OF THE INVENTION

The present invention relates to a system for accessing auxiliary content data and in particular but not exclusively to a system for use within a mobile communications system and for playing a game on a user equipment.

### BACKGROUND OF THE INVENTION

Auxiliary products associated with mobile communication devices or user equipment have over the last couple of years become popular. These products include ringtones, background wallpapers displayed on the user equipment, and games.

These games are often supplied to the user equipment in the form of a physical device such as a multimedia card (MMC), or over the user equipment communications link from an external memory source to a memory within the user equipment.

This data once loaded into the user equipment is typically fixed. In other words the user of the application data is not generally able to change aspects of the game/ringtone/wallpaper.

In other areas of computer gaming there is a growing popularity for games that allow the user to play the game using different characters or using different rules. An example of such games are role playing games, where the user explores a virtual world from the viewpoint of a fantasy or real-life character. A further example are sports management games where the user manages a sports team, the team comprising various characters with varying attributes.

Due to the finite amount of memory within the MMC and user equipment it is sometimes not possible to provide more than a small range of variation for rules and characters.

It is the aim of embodiments of the present invention to provide, address or at least mitigate the problems described above.

### SUMMARY OF THE INVENTION

According to one aspect of the present invention there is provided a communications system for operating in a cellular communications network, the system comprising: user equipment comprising a first communications port; said user equipment being arranged to operate a first application and a card for accessing options on the user equipment applications, the card comprising: a storage element storing information relating to the application in a form readable by the port, the user equipment being arranged to receive said card-stored information via said first communications port. said storage element information being such as to allow a user to access an option in the application in dependence on said stored information; a visual display element, arranged to display information dependent on the information representative of the option.

Said storage element may comprise at least one of: a smart card; a grid of indicia; a barcode; punched holes; an radio-frequency identification (RFID) chip; a password; and a magnetic strip.

Said storage element information may comprise additional application information. Said application may be arranged to access said option by appending said additional application information to said application.

Said storage element information may comprise access information. Said application may be arranged to access said option by unlocking access to said application in dependent on said access information.

Said visual display element may comprise a card status indicator. Said card status indicator may provide a visual cue after said card has been used at least once, and not before.

Said card may have user-removable obscuring means obscuring reading of the visual display element.

Said system may further comprise a card reader, said card reader being arranged to access said card stored information from said card and transmit said information to said first communications port. Said card reader may be arranged to be integral with said user equipment. Said card reader may be arranged to be detachably mounted to said user equipment. Said card reader is arranged to be separate from said user equipment; said card reader communicating to said user equipment over a communications link. Said communication link may comprise a wired or a wireless link.

Said user equipment may further comprise a second communications port, said second communications port being arranged to communicate signals over a cellular network.

The system may further comprise a server. Said storage element information may then comprises server information. The server information may be information stored by and/or suitable for operation with the server.

Said user equipment may be arranged to communicate to and from said server over said cellular network in dependence on said server information stored in said storage element.

Said server may comprise at least one of: access information; or additional application information. Said server may pass said information to said user equipment second communications port in dependence on said server information, wherein said user equipment application arranged to access said option in dependence on said information received at said second communications port.

According to a second aspect of the invention there is provided a hand portable electronic device for operating in a cellular communications network in conjunction with a card for accessing options on the device, the card comprising a storage element storing information relating to an application, the storage element information being such as to allow a user to access an option in the application in dependence on said stored information; the hand portable electronic device being arranged to operate the application and comprising: a first communications port for reading the storage element information, the user equipment being arranged to receive said card-stored information via said first communications port; and a visual display element, arranged to display information dependent on the information representative of the option.

According to a second aspect of the invention there is provided a program for execution by a hand portable electronic device that is capable of operating in a cellular communications network in conjunction with a card for accessing options on the device, the card comprising a storage element storing information relating to an application, the storage element information being such as to allow a user to access an option in the application in dependence on said stored information; the program being executable to provide an application operable by the device and being arranged to read the storage element information via a communications port of the electronic device and to control a visual display element of the electronic device to display information dependent on the information representative of the option. The program may be stored on an information carrier such as a ROM.

### BRIEF DESCRIPTION OF DRAWINGS

For a better understanding of the present invention and how the same may be carried into effect, reference will now be made by way of example only to the accompanying drawings in which:

FIG. 1 shows a schematic view of a typical mobile communications device within a mobile communications environment incorporating an embodiment of the present invention;

FIG. 2 shows a schematic view of a series of embodiments of the invention incorporated within various card technologies;

FIG. 3 shows a schematic view of embodiments of embodiments of the invention as they are combined with mobile communication devices;

FIG. 4 shows a flow diagram showing the method used in performing an update action as applied to a mobile communications device for an embodiment of the present invention.

### DETAILED DESCRIPTION OF EMBODIMENTS OF THE PRESENT INVENTION

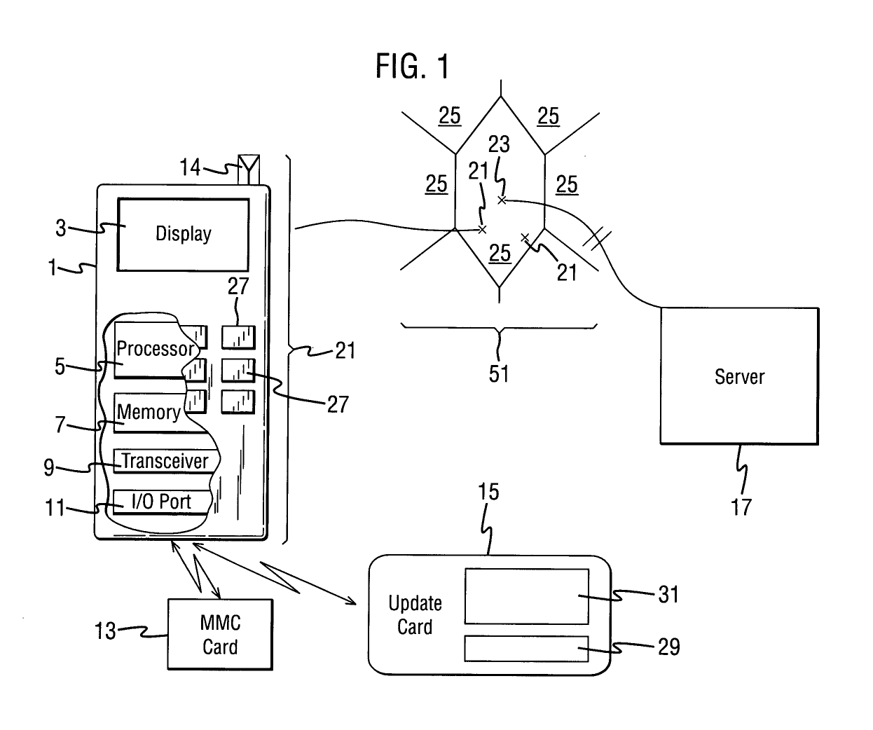

Reference is made to FIG. 1, which shows a mobile communications device otherwise known as user equipment incorporated in a cellular communications system into which embodiments of the present invention may be implemented.

The cellular communications system 51 is a telecommunications system which divided into a series of areas known as cells 25. Each cell 25 has at least one base transceiver station (BTS) 23 within the cell boundary. The base transceiver stations transmit signals to and receive signals from user equipment (UE) 21. In some embodiments of the present invention the user equipment (UE) 21 can communicate directly to other user equipment (UE) 21 without the need to communicate via the BTS 23. In other embodiments of the present invention base transceiver stations (BTS) 23 can communicate between other base transceiver stations (BTS) 23.

User equipment (UE) 21, can for example comprise mobile telephones, personal digital assistants (PDAs), and personal computers with transceiver capability. User equipment 21, as shown in FIG. 1, is a mobile telephone.

The user equipment 21 comprises an external case 1 for protecting the internal components, a display 3 for displaying text and graphical information to the user, keypad 27 for providing a user selection interface, antenna 19 for physically transmitting and receiving signals over the wireless communications link, and I/O port 11 for physically transmitting and receiving signals over a short-range communications link. The I/O port 11 in some embodiments of the present invention is located within the case.

The user equipment further comprises a processor 5 for processing received instructions and data; internal memory 7 for storing instructions and data; transceiver 9 for converting data into signals to be transmitted by the antenna 19 or I/O port 11, and also for converting received signals from the antenna 19 or I/O port 11 to data.

FIG. 1 also shows two usual methods for providing the user equipment 21 with the data required for a game. As described earlier user equipment can be supplied with data for games from multimedia cards (MMC) 13. MMCs 13 interface with the user equipment 21 via the I/O port 11, and can be accessed directly from the processor 5 or can load some or all of the data stored in the MMC to the user equipment memory 7 to be accessed by the processor 5.

A second method for providing the user equipment 21 with the data required for a game to operate is to transfer the data from a remote server 17 connected to the cellular communications system 51 into the memory 7 of the user equipment 21.

In other words the user equipment 21 sets up a communication channel from the user equipment 21 to the remote server 17 via the base transceiver station 23. The user equipment 21 requests the game from the server 17. The server 17 passes the game data to the BTS 23, and he BTS 23 transmits the game data over the cellular communications link to the user equipment 21.

Once the game is loaded into the memory 7 or the game MMC 13 connected to the user equipment 21 the user can access the game. As known in the art the game can be provided inputs using the keypad 27, which are detected and processed by the processor 5 and information provided on the display 3.

Upgrades or unlocked features for the game can be carried out in embodiments of the present invention by an update card 15.

The update card 15 comprises a smart-card 29 and a visual identification element 31. The smart-card 29 is configured to physically interface with the user equipment 21 via the I/O port 11. The smart-card 29 contains data containing new elements for the game described above. This data is read from the smart-card 29 and stored in the memory 7.

In some embodiments of the present invention the data is deleted from the smart-card 29 as it is transferred from the update card 15 to the memory 7 to prevent the information being used by other than the original user of the update card 15.

For example in a football manager game, each update card 15 has a smart card 29 containing the statistics of a football player. Once the smart-card 29 has been read the user can select the player. After the player is selected, the statistics are transferred into the memory 7 and the statistics deleted from the smart-card 29.

The visual identifier 31 comprises an image identifying that the update card 15 is for use with a specific game or range of games. Using the football manager game example, the visual identifier 31 can be a picture of the football player together with a visual display of at least some of the statistics relating to the player. Preferably the update cards 15 can be designed in such a way that the cards are perceived to have a value after they have been used to update the game.

In some embodiments of the present invention the visual identifier is a holographic or pseudo-holographic image.

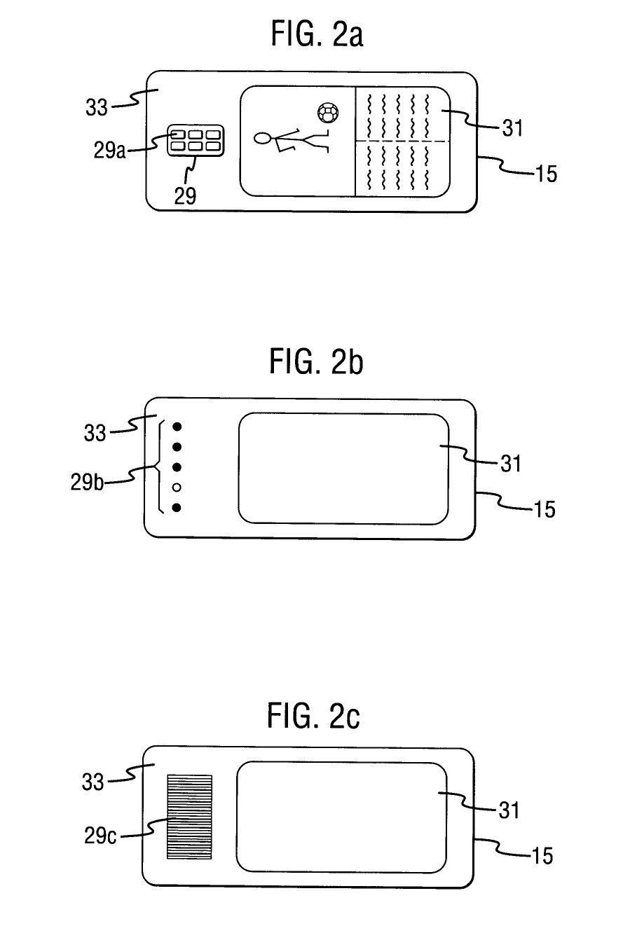

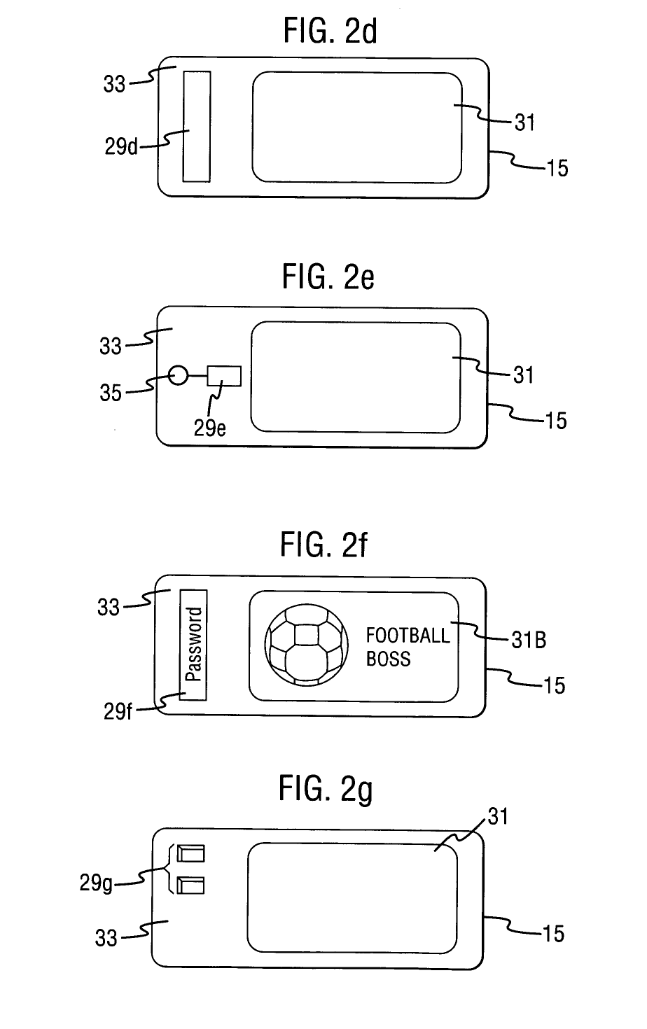

With reference to FIG. 2a the update card 15 described above is shown in further detail. The update card 15 is a card body 33, on which or within which the smart-card 29 and visual identifier 31 are formed. The smart-card 29 shown in this embodiment of the invention is located near one edge of the update card 15, with contact pins 29a forming a conductive contact with a physical reader (not shown in FIG. 2a) in order to communicate with the user equipment 21. The visual identifier 31 is located at the opposite edge of the update card 15. The card body can be made from a commonly used material such as card or plastic.

With reference to FIG. 2b a second embodiment of the present invention is shown. The update card 15 is made from a card body 33 marked with a grid of dots 29b rather than the smart-card 29. The grid of dots 29b can be formed on a front side of the card body 33 by indenting the material from the reverse side. The grid of dots 29b is readable by the I/O port 11. The grid of dots 29b contains information that is used by the game allow the player to access new elements for the game. The update card 15 further comprises a visual identifier 31 similar to those described in the previous embodiment.

With reference to FIG. 2c, a third embodiment of the present invention is shown. The update card 15 in this embodiment comprises a bar code 29c rather than the smart-card 29. The bar code 29c is printed on the card body 33. In further embodiments the card body 33 is transparent or translucent and the bar code 29c is embedded within the card body 33. The bar code 29c is readable by the I/O port 11. The bar code contains information containing new elements for the game described above. The update card 15 further comprises a visual identifier 31, similar to those described earlier.

With reference to FIG. 2d, a fourth embodiment of the present invention is shown. The update card 15 comprises a magnetic strip 29d rather than a smart-card 29. The magnetic strip 29d is integral to the card body 33 where the card body 33 is made from magnetically programmable material. In other embodiments of the present invention the magnetic strip 29d is a separate strip of magnetically programmable material attached to the card body 33. The magnetic strip 29d is readable by the I/O port 11. The magnetic strip 29d contains information detailing new elements for the game described above. The update card 15 further comprises a visual identifier 31, similar to those described earlier.

With reference to FIG. 2e, a fifth embodiment of the present invention is shown. The update card 15 comprises a radio frequency identification chip (RF-ID) 29e connected to a loop antenna 35 instead of a smart-card 29. The RF-ID chip 29e and RF-ID loop antenna 35 is located on or in the card body 33. The RF-ID chip 29e is wirelessly readable by the I/O port 11. The RF-ID chip 29e contains information containing new elements for the game described above. The update card 15 further comprises a visual identifier 31, similar to those described earlier.

With reference to FIG. 2f, a sixth embodiment of the present invention is shown. The update card 15 comprises a password 29f printed on the card body instead of a smart-card 29. The password 29f is readable by the I/O port 11. In some embodiments of the present invention the password 29f is entered to the user equipment 21 by the user to the application using the keypad 27. The password 29f contains information containing new elements for the game described above. In some embodiments of the invention the password 29f is covered by a removable opaque film, such as metal foil glued over the password 29f, which can be removed by the user prior to reading the password 29f.

The update card 15 further comprises a visual identifier similar to those described above.

In some embodiments of the present invention the visual identifier 31b as shown in FIG. 2f shows a visual identifier which does not provide an indication of the contents of the card other than which game or range of games the update card 33 can be used with. Continuing the same example as described earlier the visual identifier 31b is the logo of the football game and contains no information on the player information contained within the card.

With reference to FIG. 2g a seventh embodiment of the present invention is shown. The update card 15 comprises a series of punched holes 29g in the card body 33. The punched holes 29g are readable by the I/O port 11. The position and number of the punched holes 29g contains information containing new elements for the game described above. The update card 15 further comprises a visual identifier 31, similar to those described earlier.

In further embodiments of the present invention the information stored on the update card 15 is information enabling a user to unlock or enable access to previously hidden parts of the game. For example the information stored could unlock access to levels of the game otherwise accessed by completing specific tasks.

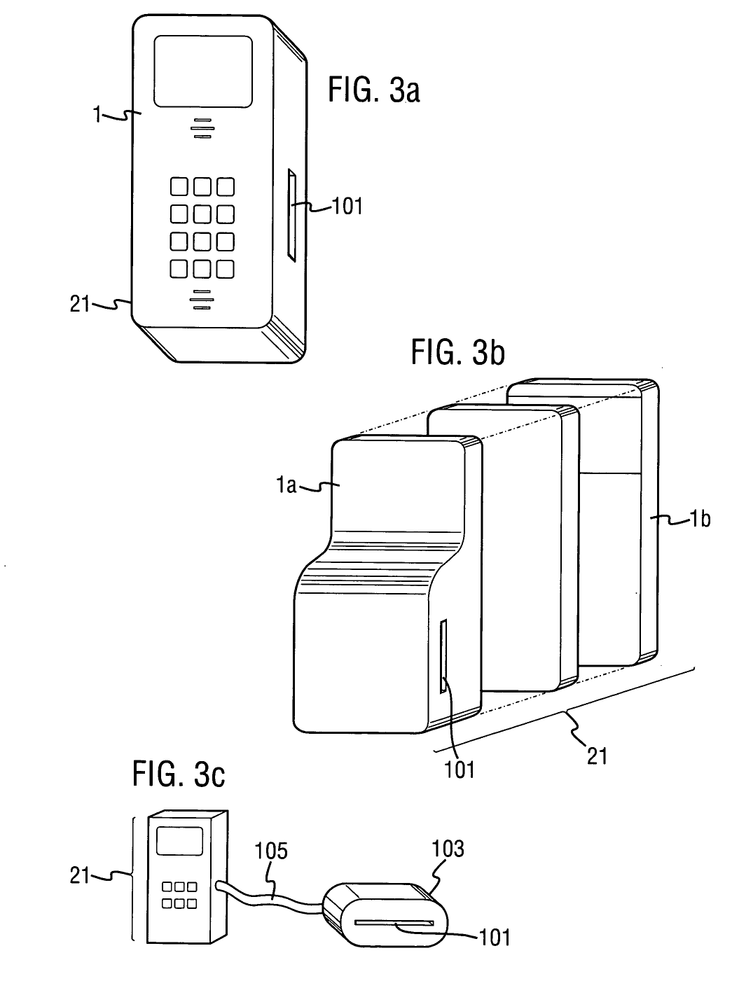

With reference to FIG. 3a to FIG. 3c three different card reader embodiments of the present invention are shown. With reference to FIG. 3a, the user equipment 21 case 1 contains a card slot 101 located on one side of the case 1. The card slot 101 is designed to accept the update card 15 and to be connected to the I/O port 11. In order to use the update card 15, the user physically inserts the update card 15 into the card slot 101, and reader circuitry contained within the case 1 reads the update card 15 and transfers the data to the I/O port 11.

With reference to FIG. 3b, the user equipment 21 external case 1 comprises two parts 1a and 1b. At least one of these removable parts 1a contains a card slot 101, designed to accept and read update cards 15 and also connected to the I/O port 11. In a manner similar to the method described above the user inserts the update card 15 into the card slot 101 in order to access the information on the update card 15.

The use of removable case parts has the added advantage that it is possible to replace the card reader part 1a of the case 1 with a smaller, lighter part (not shown) when card reading is not required.

With reference to FIG. 3c, the user equipment 21 is shown to be in physical connection over wired communications link 10s to a card reader 103 comprising a card slot 101. The wired communications link 105 connects the card reader 103 to the I/O port 11. In some embodiments of the present invention the communications link connecting the card reader 103 to the I/O port 11 is a wireless communications link, such as a radio frequency (e.g. Bluetooth) or Infra red Data Access (IrDA) wireless link.

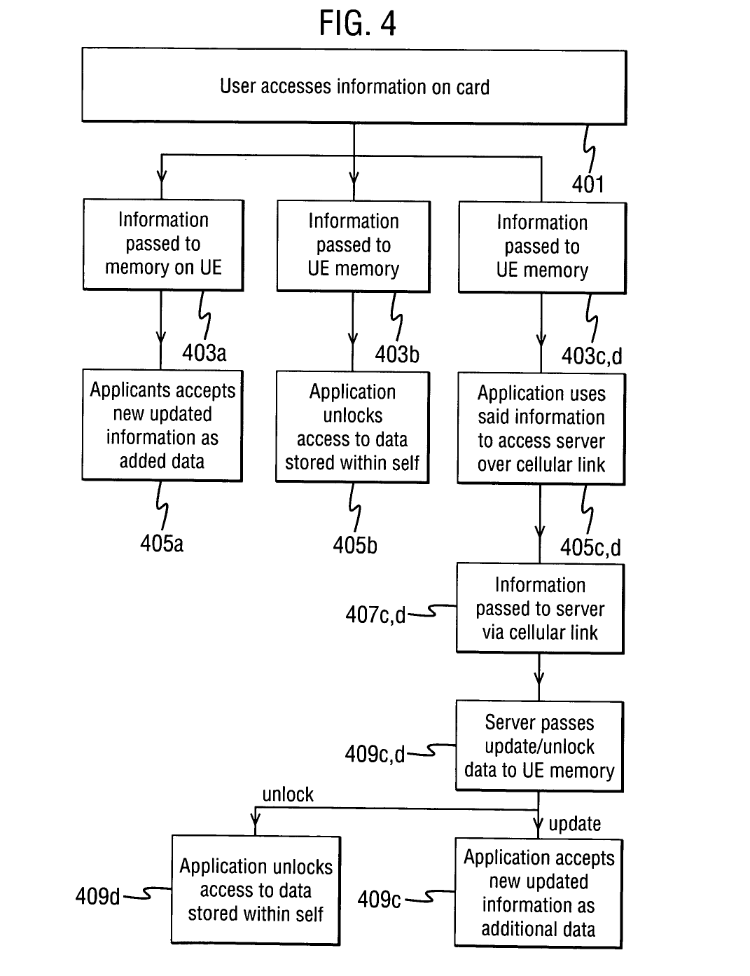

With reference to the flow diagram of FIG. 4, the methods used in embodiments of the present invention are shown. The first two branches (a) and (b) of FIG. 4 describe methods that use information stored on the card to access new elements for the game described above. The second two branches describe methods that use the information stored on the card to access further data in order to access new elements for the game described above.

The first method branch (a) describes the method where the game data contained on the update card 15 comprises additional game data, for example game character data, or additional game level data.

In a first step 401, the user equipment 21 accesses the game data in the form of additional game data from the update card 15.

The additional game is read from the card and passed to the memory 7 in step 403a.

In step 405a the additional game data is accepted by the previously loaded game. The user is able to select and use the additional game data.

The second method branch (b) of FIG. 4 describes a further embodiment of the present invention where the information contained on the update card 15 is a code enabling the user to enable access a previously inaccessible part of the game. For example the information could contain a game cheat code enabling the user to more easily complete the game, or reveal a hint enabling the user to more easily complete the game.

In a first step 401, the user equipment accesses the information in the form of access data stored on the update card 15.

The access data is read from the card and passed to the memory 7 in step 403b.

In step 405b the access data is accepted by the game. The user is able to select and use the newly accessible parts of the game.

The third and fourth method branches describe further embodiments of the present invention. The third branch (c) and fourth branch (d) are those where the information contained on the update card enables the user equipment 21 to access a remote server 17 in order to download either additional game data (c) or access data (d). The (c) and (d) branches are differ only on their final application of the data and the common elements described together.

In a first step 401, the user equipment accesses the information in the form of server information stored on the update card 15.

The server information is read from the update card 15 and passed to the memory 7 in step 403c,d.

In step 405c,d, the game uses the server information to access the external server 17 over the cellular communications network 51.

The server 17 is passed any required server information in step 407c,d. This server information could be authentication or authorisation information allowing the server to determine that the user is entitled to the update information, or is entitled to specific update.

Based on the server information the server 17 passes, in step 409c,d, the authorised additional game data or access data to the user equipment 21 via the cellular communications network 51.

Where the server passes unlock or access data, the method proceeds to step 411d, where the access data is accepted by the game. The user is able to select and use the newly accessible game elements.

Where the server passes update or additional game data, the method proceeds to step 411c, where the additional game data is accepted by the game. The user is able to select and use the additional game data.

Preferably the cards can be designed in such a way that the cards are perceived to have a value after they have been used to upgrade or update the application. For example where the application is a football computer game, the unlock card 15 can contain the updated game character of a footballer, the design of the unlock card containing a picture of the footballer and containing career details.

In the embodiments of the present invention where the update card 15 does not visibly state exactly what characteristics is contained within the update card 15, users of the cards can choose not to use the card where a card with identical elements has been used before.

In such an embodiment the user is able to pass the update card 15 to a third party. The user may therefore choose to swap used or unused update cards 15 to acquire a desired update card 15.

In further embodiments of the present invention the visual identifier 31 further comprises a card status indicator. The card status indicator provides a visual cue to whether the card has already been used.

In further embodiments of the present invention the update card 15 is used to update or unlock auxiliary user equipment products. For example the update card 15 is used to enabling access to or provide ringtones or wallpaper designs.

In further embodiments of the present invention the update card 15 could have user-removable obscuring means, such as an envelope or scratch-off coating, obscuring reading of the visual display element.

1. A communications system for operating in a cellular communications network, the system comprising:
user equipment including a first communications port, wherein said user equipment is configured to operate a first application and
a card for accessing options on the application, the card including:
a storage element storing first information relating to the application in a form readable by the first communications port, wherein the user equipment is configured to receive said first information via said first communications port;
said first information allows a user to access an option in the application in dependence on said first information; wherein said first information comprises access information, wherein said application is configured to access said option by unlocking access to said application according to said access information and
a visual display element configured to display second information dependent on the first information representative of the option.

2. A system as claimed in claim 1, wherein said storage element comprises at least one of:
a smart card;
a grid of indicia;
a barcode;
punched holes;
an radio-frequency identification (RFID) chip;
a password; and
a magnetic strip.

3. A system as claimed in claim 1, wherein said first information comprises additional application information, wherein said application is configured to access said option by appending said additional application information to said application.

4. A system as claimed in claim 1, wherein said visual display element comprises a card status indicator, wherein said card status indicator provides a visual cue after said card has been used at least once.

5. A system as claimed in claim 1, wherein said card includes user-removable obscuring means obscuring reading of the visual display element.

6. A communications system as claimed in claim 1, further comprising a card reader, wherein said card reader is configured to access said first information from said card and transmit said first information to said first communications port.

7. A communications system as claimed in claim 6, wherein said card reader is configured to be integral with said user equipment.

8. A communications system as claimed in claim 6, wherein said card reader is configured to be detachably mounted to said user equipment.

9. A communications system as claimed in claim 6, wherein said card reader is configured to be separate from said user equipment, and wherein said card reader communicates to said user equipment over a communications link.

10. A communications system as claimed in claim 9, wherein said communication link comprises a wired link.

11. A communications system as claimed in claim 9, wherein said communications link comprises a wireless link.

12. A communications system as claimed in claim 6, wherein said user equipment further comprises a second communications port, wherein said second communications port is configured to communicate signals over a cellular network.

13. A communications system as claimed in claim 12, further comprising a server, wherein said first information comprises server information.

14. A communications system as claimed in claim 13, wherein said user equipment is configured to communicate to and from said server over said cellular network according to said server information stored in said storage element.

15. A communications system as claimed in claim 14, wherein said server comprises at least one of:
access information; and
additional application information, and
wherein said server passes said access information or said additional application information to said second communications port according to said server information, wherein said user equipment application is configured to access said option according to said access information or said additional application information received at said second communications port.

16. A hand portable electronic device for operating in a cellular communications network in conjunction with a card for accessing options on the device, the card comprising a storage element storing information relating to an application, the storage element information to allow a user to access an option in the application in dependence on said stored information, wherein said information comprises access information, wherein said application is configured to access said option by unlocking access to said application according to said access information, wherein the hand portable electronic device is configured to operate the application, the hand portable electronic device comprising:
a first communications port for reading first information, wherein the device is configured to receive said first information via said first communications port; and
a visual display element configured to display second information dependent on the first information representative of an option.

17. A program embodied on a computer-readable medium for execution by a hand portable electronic device that is capable of operating in a cellular communications network in conjunction with a card for accessing options on the device, the card comprising a storage element storing information relating to an application, wherein the information allows a user to access an option in the application in dependence on said information, wherein said information comprises access information, said application being configured to access said option by unlocking access to said application according to said access information, and the program controls the hand portable electronic device to perform the steps of:
providing an application operable by a device and configured to read storage element information via a communications port of the device and to control a visual display element of the device to display information dependent on the storage element information representative of an option.

18. A hand portable electronic device for operating in conjunction with a card for accessing options on the device, the card comprising a storage element storing information relating to an application, the information allows a user to access an option in the application in dependence on said information, wherein said information comprises access information, wherein said application is configured to access said option by unlocking access to said application according to said access information, wherein the hand portable electronic device is configured to operate the application, the hand portable electronic device comprising:
reading means for reading stored information from a first communications port, wherein the device is configured to receive said stored information via said first communications port; and
displaying means for displaying a visual display element configured to display information dependent on the stored information representative of an option.
